(19) United States
(12) Patent Application Publication
(10) Pub. No.: US 2007/0099621 A1
(43) Pub. Date: May 3, 2007

(54) Cell transfer during MBMS session with advance provision of mobile station ID

(76) Inventors: Jens Daniel Bergqvist, Linkoping (SE); Hakan Persson, Solna (SE)

Correspondence Address: ERICSSON INC., 6300 LEGACY DRIVE, M/S EVR 1-C-11, PLANO, TX, 75024, US

(21) Appl. No.: 11/263,235

(22) Filed: Oct. 31, 2005

(51) Int. Cl. H04Q 7/20

(52) U.S. Cl. 455/445

(57) ABSTRACT

A mobile station which is participating in a Multimedia Broadcast Multicast Service session, and which will continue its session participation in a new cell, need not wirelessly obtain from the new cell an identifier to use for the session in the new cell. Rather, the mobile station wirelessly obtains the identifier from the cell that is to be exited in favor of the new cell. This can reduce the session interruption associated with the cell change.

### FIELD OF THE INVENTION

The invention relates generally to wireless communications and, more particularly, to Multimedia Broadcast Multicast Service (MBMS) in wireless communications.

### BACKGROUND OF THE INVENTION

Multimedia Broadcast Multicast Service (MBMS), well known in the art of wireless communication, supports broadcast and multicast data communication to multiple users at the same time using shared network resources. This saves resources in the core network and the radio access network. Broadcast services typically transmit data to a certain area so that any users in that area can receive the data. Multicast services typically transmit data that is to be received only by those users who subscribe to the multicast service. Multicast service subscribers typically use an encryption key or other suitable mechanism to decipher the received multicast data.

The 3rd Generation Partnership Project (3GPP) has specified the provision of MBMS in the GSM/EDGE Radio Access Network (GERAN). The formal specification document, 3GPP Technical Specification 43.246 “Multimedia Broadcast Multicast Service (MBMS) in the GERAN”, is incorporated herein by reference. Related specification documents 3GPP Technical Specification 44.060 “Radio Link Control/Medium Access Control (RLC/MAC) Protocol”, and 3GPP Technical Specification 48.018 “BSS GPRS Protocol (BSSGP)” are also incorporated herein by reference.

GERAN can support MBMS sessions according to either a feedback mode or a non-feedback mode. In the non-feedback mode, the base station system (BSS) transmits RLC blocks without receiving any feedback from the mobile stations (MSs) regarding reception of the RLC blocks. In order to limit the error rate in the MSs, the BSS typically retransmits each RLC block some predetermined number of times. In feedback mode, the MSs send acknowledgement messages on the RLC layer to the BSS, so the BSS can retransmit only those RLC blocks that have not been received by all MSs. In any given cell that is supporting an MBMS session in feedback mode, each MS that is participating in the MBMS session is allocated an associated identifier (MS_ID). The BSS uses the MS_IDs to request feedback acknowledgement reports from the respective MSs.

In order to limit the interruption in an MS's reception of an ongoing MBMS session when the MS moves from one cell to another, the BSS provides, to all MSs that are currently participating in a given MBMS session, information indicative of the location of the bearers that are supporting the MBMS session in neighboring cells. Thus, upon changing cells, an MS can begin listening to the MBMS session in the new cell relatively quickly.

In the aforementioned feedback mode, the MSs send to the BSS measurement reports for the strongest neighboring cells. If an MS has triggered cell reselection to a neighboring cell, then the MS uses a measurement report to inform the BSS of that cell reselection. The BSS can then give priority to transmitting, in the “old” cell, the location of the corresponding MBMS bearer in the new cell. In such instances, the MS delays transitioning into the new cell up to one second, in order to provide an opportunity to receive from the BSS the MBMS bearer location information for the new cell.

If the new cell also uses the feedback mode, then the MS must perform an access request in the new cell in order to request an MS_ID (and timing advance parameters) to use during participation in the MBMS session in the new cell. This access request, which is made via the CCCH (Common Control Channel) or PCCCH (Packet Common Control Channel) in the new cell, can result in an interruption of the MS's reception of the MBMS session. The MS will not be able to provide feedback on the RLC layer until an MS_ID has been allocated to it.

There have also been proposed MBMS bearers that do not require the MSs to listen to the CCCH/PCCCH in parallel with the MBMS bearer. This implies system configurations and/or operating modes wherein the MS cannot listen to the CCCH/PCCCH and the MBMS bearer at the same time. In such instances, the interruption of the MS's participation in the MBMS session would be extended, because the MS would need to remain in non-DRX mode for some time.

It is desirable in view of the foregoing to provide for reducing the amount of MBMS session interruption that occurs when an MS switches from one cell to another where feedback mode is used.

According to exemplary embodiments of the invention, an MS entering a new cell need not perform an access request procedure in the new cell to obtain an MS_ID for use in that cell. Rather, the MS_ID for the new cell is provided to the MS while the MS is still in communication with the cell that will be exited in favor of the new cell. This can reduce the session interruption associated with the cell change.

### BRIEF DESCRIPTION OF THE DRAWINGS

FIG. 1 illustrates exemplary operations that can be performed according to the invention when a mobile station changes cells while participating in a feedback mode MBMS session.

FIG. 2 diagrammatically illustrates a wireless communication network according to exemplary embodiments of the invention.

FIG. 3 diagrammatically illustrates a mobile wireless communication apparatus according to exemplary embodiments of the invention.

### DETAILED DESCRIPTION

According to exemplary embodiments of the invention, when an MS that is operating in feedback mode and participating in an MBMS session announces to the currently serving BSS a transfer form the current cell to a new cell, the currently serving BSS can, while the MS remains in communication with the current cell, allocate an MS_ID which the MS can use to continue participating in the MBMS session in the new cell. Some embodiments transmit the MS_ID parameter from BSS to MS by adding a new information element to a conventionally available message. For example, a new information element, addressed only to the MS that has reported the cell change, can be added to the existing MBMS NEIGHBOURING CELL INFORMATION message. Other embodiments transmit the MS_ID parameter in a suitable message on the PACCH (Packet Associated Control Channel) of the MBMS point-to-multipoint bearer that is supporting the MS's session in the current cell.

In situations where the same BSS that handles the current cell also handles the new cell, the BSS can readily allocate an MS_ID for the MS to use in the new cell.

In situations where the current and new cells are handled by different BSSs, some embodiments use a RIM application to support the allocation of an MS_ID for the MS to use in the new cell. The currently serving BSS (which handles the current cell) can use a suitable Radio Access Network Information Management (RIM) application to request the new BSS (which handles the new cell) to allocate an MS_ID for the MS, and the new BSS can, after allocating the requested MS_ID, use the RIM application to communicate the allocated MS_ID to the currently serving BSS. The RIM procedure, including its different applications, is set forth in the aforementioned specification document 3GPP TS 48.018. Other embodiments signal the MS_ID allocation request from the current BSS and the response from the new BSS on a communication path that includes the interfaces between the BSSs and their associated Serving GPRS Support Nodes (SGSNs), and the interface between the two SGSNs.

When the new cell is handled by a different BSS than the current cell, the amount of time required to allocate the MS_ID, and then report the allocated MS_ID to the MS, can be longer than the amount of time that the MS conventionally waits for the currently serving BSS to identify the appropriate MBMS bearer in the new cell. In some embodiments, the currently serving BSS notifies the MS to wait longer in the current cell before switching to the new cell. For example, in some embodiments, the currently serving BSS provides in the MBMS NEIGHBOURING CELL INFORMATION message an information element which indicates that, for transitions to certain neighboring cells (i.e., those handled by a different BSS), the MS should wait for the longer period of time.

As demonstrated above, with the present invention, the MS_ID for use in the new cell can be provided without executing the conventional access request procedure. However, the access request procedure is also used in conventional systems to provide the MS with the timing advance parameters that it will use to send acknowledgement reports to the new BSS. More specifically, the conventional access request procedure is initiated by the MS sending access bursts for the network to use in determining timing advance parameters for use by the MS.

Exemplary embodiments of the invention provide for the determination of timing advance parameters for the MS, even though the access request procedure is not executed. After the MS transitions to the new cell, the new BSS will begin to poll the MS for acknowledgement reports with respect to the MBMS session. In some embodiments, the MS initially responds to this polling by sending access bursts instead of acknowledgement reports. The BSS uses these access bursts to determine the timing advance parameters for the MS. In some embodiments, rather than having the MS send access bursts instead of acknowledgement reports in response to initial BSS polling, the conventional PACKET POLLING REQUEST procedure is used to elicit from the MS access bursts that can be used by the BSS to determine the timing advance parameters for the MS.

In some embodiments, the timing advance parameters are reported to the MS in a PACKET POWER CONTROL/TIMING ADVANCE message on the PACCH. Some embodiments address this message specifically to the desired MS by, for example, including in the Global TFI IE field of the message both the MBMS Bearer Identity and the MS_ID of the desired MS. In other embodiments, the BSS uses the PACCH to send to the MS a control message that contains the timing advance parameters.

After the MS receives the timing advance parameters, the MS can thereafter respond with acknowledgement reports (which include the MS_ID) when the BSS polls for acknowledgement reports.

The new BSS will know that the MS has moved to the new cell as soon as the BSS begins to receive access bursts in response to its polling of the MS. At that time, the network also knows that the “old” MS_ID that was previously used by the MS in the exited cell can be re-allocated to another MS currently operating in the exited cell. Because the access request procedure has been avoided, the corresponding time delay required to perform the access request procedure is eliminated, so the “old” MS_ID can be re-allocated earlier than would be possible if the access request procedure were performed.

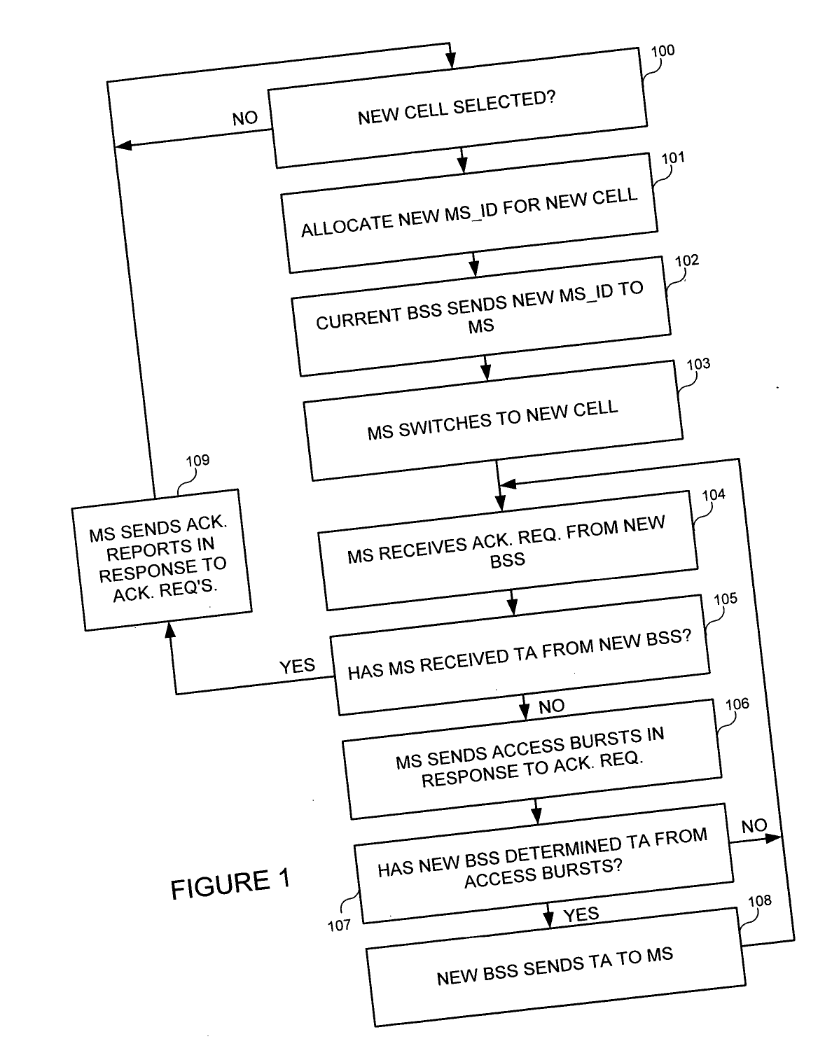

FIG. 1 illustrates how operations such as described above can be performed according to exemplary embodiments of the invention when a mobile station changes to a cell that is supporting an MBMS session in feedback mode. After a new cell is selected (and reported from MS to BSS) at 100, a new MS_ID for the MS to use in the new cell is allocated at 101. After the new MS_ID has been allocated, the current BSS sends it to the MS at 102. The MS switches to the new cell at 103. At 104, the MS receives an acknowledgement request from the new BSS. As illustrated at 104-108, until the MS has received timing advance (TA) parameters from the new BSS (see 105, 107 and 108), the MS will send access bursts (see 106) in response to an acknowledgement request received from the new BSS. As illustrated at 107 and 108, when the new BSS has determined the TA parameters from the access bursts (see 107), the new BSS then sends the TA parameters to the MS (see 108). As shown at 105 and 109, after the MS has received the TA parameters from the new BSS (see 105), the MS will send acknowledgement reports (see 109) in response to acknowledgement requests received from the new BSS.

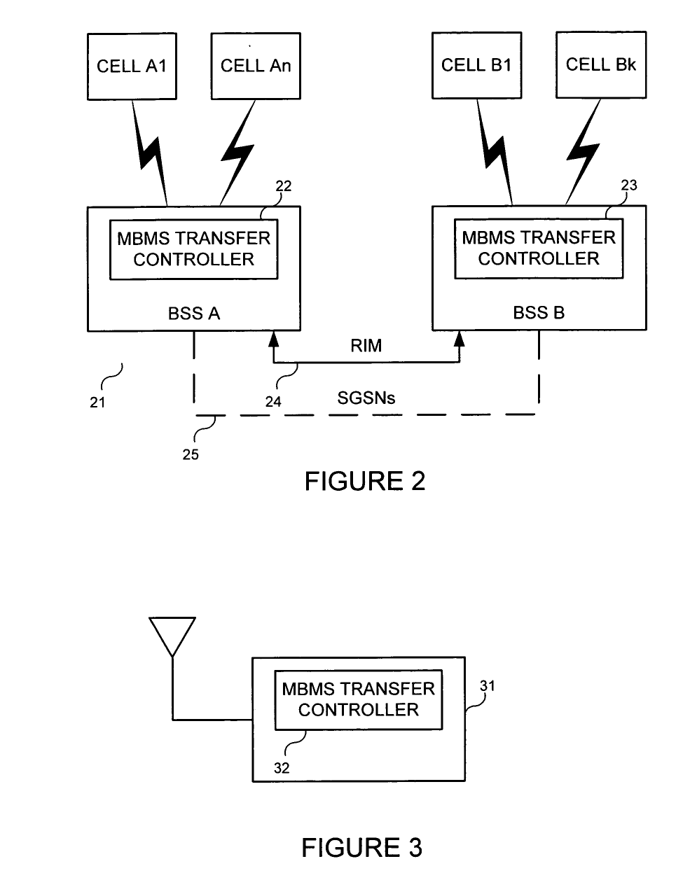

FIG. 2 diagrammatically illustrates a wireless communication network according to exemplary embodiments of the invention. In FIG. 2, BSS A serves mobile stations operating in a plurality of cells designated A1-An, and BSS B serves mobile stations operating in a plurality of cells designated B1-Bk. Network infrastructure supporting the use of RIM applications for communication between BSS A and BSS B is illustrated at 24. Embodiments that use SGSNs for communication between BSS A and BSS B are illustrated by broken line at 25. BSS A includes an MBMS transfer controller 22 coupled with a wireless communication interface to the served cells A1-An, and BSS B includes an MBMS session controller 23 coupled with a wireless communication interface to the served cells B1-Bk. In some embodiments, either of the MBMS transfer controllers 22 and 23 is capable of suitably controlling conventionally available facilities (not all explicitly shown) in the associated BSS in order to effectuate operations described above with respect to either the “currently serving” BSS or the “new” BSS.

FIG. 3 diagrammatically illustrates a mobile station apparatus 31 according to exemplary embodiments of the invention. The apparatus 31 includes an MBMS transfer controller 32 coupled to a wireless communication interface. In some embodiments, the MBMS session transfer controller 32 is capable of suitably controlling conventionally available facilities (not all explicitly shown) in the apparatus 31 in order to effectuate operations described above with respect to the mobile station MS.

As demonstrated above, exemplary embodiments of the invention can avoid the use of the access request procedure when the MS enters a new cell. Avoiding the access request procedure provides various advantages, for example: (1) the corresponding interruption of the MS's participation in the MBMS session is avoided;

(2) the corresponding load on the common control channels ((P)RACH and (P)CCCH) in the new cell (which would otherwise support the access request procedure) is reduced; and (3) the MS_ID previously used by the MS in the exited cell can be re-allocated to another MS sooner.

Although exemplary embodiments of the invention have been described above in detail, this does not limit the scope of the invention, which can be practiced in a variety of embodiments.

What is claimed is:

1. A method of providing user mobility during a Multimedia Broadcast Multicast Service (MBMS) session, comprising:
wirelessly communicating in a first wireless communication cell first information that is used in the first wireless communication cell to identify a user as a participant in the MBMS session; and
without conducting wireless communication in a second wireless communication cell, providing for said user second information that is used in the second wireless communication cell to identify said user as a participant in the MBMS session.

2. The method of claim 1, wherein said providing step includes wirelessly communicating said second information in said first wireless communication cell.

3. The method of claim 2, including allocating said second information in said second wireless communication cell, and sending said second information from said second wireless communication cell to said first wireless communication cell.

4. The method of claim 1, including wirelessly communicating in the second wireless communication cell a series of acknowledgement requests associated with the MBMS session, wirelessly communicating in the second wireless communication cell a signal produced in response to said wireless communication of one of said acknowledgement requests, and wirelessly communicating in the second wireless communication cell timing advance information provided for a participant in the MBMS session and determined based on said wireless communication of said signal.

5. The method of claim 4, wherein said providing step includes wirelessly communicating said second information in said first wireless communication cell.

6. The method of claim 5, including allocating said second information in said second wireless communication cell, and sending said second information from said second wireless communication cell to said first wireless communication cell.

7. The method of claim 4, wherein said participant is said user.

8. The method of claim 4, including, after said wireless communication of said timing advance information, wirelessly communicating an acknowledgement in said second wireless communication cell after each said wireless communication of the remainder of said acknowledgement requests.

9. A method of supporting an MBMS session, comprising:
wirelessly communicating in a wireless communication cell a series of acknowledgement requests associated with the MBMS session;
wirelessly communicating in the wireless communication cell a signal produced in response to said wireless communication of one of said acknowledgement requests; and
wirelessly communicating in the wireless communication cell timing advance information provided for a participant in the MBMS session and determined based on said wireless communication of said signal.

10. The method of claim 9, including, after said wireless communication of said timing advance information, wirelessly communicating an acknowledgement in said wireless communication cell after each said wireless communication of the remainder of said acknowledgement requests.

11. An apparatus for providing user mobility during a Multimedia Broadcast Multicast Service (MBMS) session, comprising:
a wireless communication interface which supports wireless communication of first information that is used in a first wireless communication cell to identify a user as a participant in the MBMS session; and
a controller coupled to said wireless communication interface and cooperable therewith for, without conducting wireless communication in a second wireless communication cell, providing for said user second information that is used in the second wireless communication cell to identify said user as a participant in the MBMS session.

12. The apparatus of claim 11, provided as network infrastructure.

13. The apparatus of claim 12, wherein said network infrastructure includes first and second base station systems respectively associated with said first and second wireless communication cells, and a communication path coupled between said first and second base station systems for permitting communication of said second information between said first and second base station systems.

14. The apparatus of claim 13, wherein said communication path utilizes one of a RIM application and a serving GPRS support node (SGSN).

15. The apparatus of claim 11, provided as a mobile communication station.

16. The apparatus of claim 11, wherein said controller is cooperable with said wireless communication interface for providing said second information by wireless communication in said first wireless communication cell.

17. An apparatus for supporting an MBMS session, comprising:
a wireless communication interface which supports, in a wireless communication cell, wireless communication of a series of acknowledgement requests associated with the MBMS session;
a controller coupled to said wireless communication interface and cooperable therewith to support, in the wireless communication cell, wireless communication of a signal produced in response to said wireless communication of one of said acknowledgement requests; and
said controller cooperable with said wireless communication interface to support, in the wireless communication cell, wireless communication of timing advance information provided for a participant in the MBMS session and determined based on said wireless communication of said signal.

18. The apparatus of claim 17, wherein said controller is cooperable with said wireless communication interface after said wireless communication of said timing advance information to support wireless communication of an acknowledgement in said wireless communication cell after said wireless communication of each of the remainder of said acknowledgement requests.

19. The apparatus of claim 17, provided as network infrastructure.

20. The apparatus of claim 17, provided as a mobile communication station.
